(19) United States
(12) Patent Application Publication
(10) Pub. No.: US 2018/0263324 A1
(43) Pub. Date: Sep. 20, 2018

(54) SYSTEM AND METHOD FOR PRECISELY TAILORING CLOTHING FOR INDIVIDUALS

(71) Applicant: Giovonnae F. Anderson, Santa Rosa, CA (US)

(72) Inventor: Giovonnae F. Anderson, Santa Rosa, CA (US)

(21) Appl. No.: 15/922,760

(22) Filed: Mar. 15, 2018

Related U.S. Application Data
(60) Provisional application No. 62/473,208, filed on Mar. 17, 2017.

(51) Int. Cl. A41H 3/00; A41H 1/02; A41H 1/06; G06Q 30/06

(52) U.S. Cl. CPC A41H 3/007; G06Q 30/0621; A41H 1/06; A41H 1/02

(57) ABSTRACT

A method for creating a clothing construction sloper customized to an individual's measurements, including capturing the individual's body dimensions data using a 3D scanner, extracting and storing the captured measurement data using a sloper program, and developing a printed or digital master pattern used to fit existing garments to the person.

### CROSS REFERENCES TO RELATED APPLICATIONS

The present application claims the benefit of the filing date of U.S. Provisional Patent Application Ser. No. 62/473,208, filed Mar. 17, 2017).

### STATEMENT REGARDING FEDERALLY SPONSORED RESEARCH OR DEVELOPMENT

Not applicable.

### THE NAMES OR PARTIES TO A JOINT RESEARCH AGREEMENT

Not applicable.

### INCORPORATION BY REFERENCE OF MATERIAL SUBMITTED ON A COMPACT DISC

Not applicable.

### SEQUENCE LISTING

Not applicable.

### BACKGROUND OF THE INVENTION

### Field of the Invention

The present invention relates most generally to clothing manufacture, and more particularly to patternmaking in clothing manufacture, and still more particularly to a CAD-based approach to making slopers for custom-fit clothing based on measurements obtained with a 3D scanner.

### Background Discussion

It is difficult to find and purchase clothes that fit well. The garment and fashion industries base the size of garments on fitting to a certain kind of figure representative of the eventual target market, called a “fit model.” There are fit models in every category of clothing, including men's wear, women's wear, junior wear, children's wear, etc. Once the clothing product fits the fit model, it is graded in sizes for both larger and smaller individuals based on ASTM standard grading principles for each category. These grading principles are loosely based on market averages, with the unhappy result that many garments sold in stores fit well on nearly no one.

At present slopers (i.e., garment patterns without seam allowances) are produced using one of two methods. In one method, patternmakers hand draw a pen and ink sloper on paper and then employ a scanner to convert the hand drawn pattern into a computerized digital image format. In another method, patternmakers employ a CAD-based pattern design system to design and draft a sloper using a computer. Each method is time-consuming and ill-suited for use in bespoke garment production.

In consequence, in recent years the fashion industry and garment industries have attempted to make improvements in patternmaking systems and methods. Exemplary teachings directed to such efforts include:

U.S. Pat. No. 8,165,711, to Brooking, describes a system for automatically generating a garment construction specification from traditionally generated garment design information, such as sketches, two-dimensional Computer Aided Design (CAD) files, designer notes or simply by reference to modules that codify the industry-specific knowledge of those in the garment manufacturing industry. In a final form, the specification can include details regarding the individual components of a garment and details regarding the mechanisms and mechanics by which such components can be joined to form the final garment. The embodiments teach scanning a 2D flat pattern of an existing designed garment and using OCR to develop a pattern, which is then digitally draped on a 3D avatar to fit the garment.

U.S. Pat. No. 6,907,310, to Gardner, teaches a system and method for modeling and modifying garments for integrated “virtual tailoring.” The virtual garment models relate specific design points of the garment to specific body regions in terms of explicit 3D relationship rules, enabling garments to be modified holistically, by a constrained 3D warp process, to fit different body shapes/sizes, either in order to generate a range of graded sizes or made-to-measure garments, for the purposes of visualization and/or garment production. The methods can generate 2D pattern pieces by flattening 3D representations of modified garments so that the pattern pieces can be assembled in substantially the same way as those of the base garment. The methods enable the visualization and/or production of bespoke or graded garments, and garment design modifications, within an integrated virtual tailoring environment.

U.S. Pat. No. 9,456,647, to Grove, discloses a system and method are provided for drafting garment patterns from style drawings modified by measurements obtained from photographs and selected body part measurements from the intended wearer. Pattern styles are created with a CAD-based pattern style creator system using a general ‘mannequin’ outline having the contours of generic human form, manipulating a master style template (which is a dynamic parametric drawing or a drawing defined with dynamic parameters) on the mannequin outline to create a style drawing retained from the master style template, resulting in adjustments to a pattern piece relative to the master pattern template—thus, the pattern style. The pattern pieces can be adjusted relative to user's measurements obtained from a body outline.

U.S. Pat. No. 7,479,956, to Shaw-Weeks, discloses a method of garment fitting, selection and processing which provides a photo-realistic virtual 3-D image of an individual in a physically simulated 3-D garment. The measurements of the individual may be used to produce patterns for custom made garments, or to provide alteration suggestions to fit a garment to a particular individual. The measurements and 3-D information is stored so that the individual does not need to re-input information or undergo multiple scans and can later use the information profile for shopping or for automatically sending to a manufacturer, dressmaker or tailor for the creation or alteration of a garment. Note should be made that the measurements are used to modify existing patterns from merchants to fit the prospective clients.

U.S. Pat. No. 6,473,671, to Yan, teaches a system and method for automatic custom production of garments for a specific individual. The system creates a virtual prototype model of the garment using a 3-D library database with sloper information created from formulas of generating different slopers, thus allowing the designer to generate the sloper automatically. The pattern style information is used to generate the pattern database for a customer's individual body measurements.

As can be seen from the foregoing, the ancient art of making clothing has seen in recent years a flurry of activity directed to improving patternmaking practices. Computer-based design and drafting software, as well as scanning technology, has been recruited in the effort, most using a 3-D body scanner to get a more accurate fit for a company's fit model. In such an approach, the method works not from a basic block or sloper, but from a design to fit to the model. Alternatively, the method uses a 3-D body scanner to obtain customer measurements to customize their own designs for the particular client. In no known methods or systems, however, is there employed a method for delivering a fitted sloper to a client for the client's discretionary use and modification.

The foregoing patents reflect the current state of the art of which the present inventor is aware. Reference to, and discussion of, these patents is intended to aid in discharging Applicants' acknowledged duty of candor in disclosing information that may be relevant to the examination of claims to the present invention. However, it is respectfully submitted that none of the above-indicated patents disclose, teach, suggest, show, or otherwise render obvious, either singly or when considered in combination, the invention described herein.

### BRIEF SUMMARY OF THE INVENTION

The present invention is a method for creating a custom block pattern or sloper used in clothing construction and tailoring, fitted for an individual using a 3D body scanner.

It is a principal object of the present invention to provide an individual with a basic fitting pattern (sloper) customized to their particular measurements and body idiosyncrasies, as captured using a 3D scanning system. The pattern can be used to (1) modify “ready-to-wear” garments to achieve a better fit; (2) modify commercial patterns to achieve a great fit from garments made from these commercial patterns; or (3) work with a designer or tailor to make custom and specialty clothing that fits without having to spend time fitting the garment to the person.

In the simplest terms, the system and method of the present invention includes taking a 3D body scan of a specific person, using software executed on a computer having a processor and selectively extracting and storing measurement data from the scan, and using the extracted data to develop a master pattern for that person. The master pattern can then be used to fit existing garments to the same person. The master pattern is used either in a hard (printed) copy or digitally to alter existing patterns to fit the client.

Another object and advantage of the present invention is to provide a system and method to create a custom block pattern or sloper for an individual quickly and accurately. A sloper is a close-fitting pattern with no design ease and is the basis of all flat pattern clothing design.

Measurements obtained through the scanner are stored and used to give the basic geometry of a particular sloper (bodice, pants, sleeve, etc.), and the sloper is then draped onto the person's digital representation to check the sloper fit. This fitting often reveals the individual's physical idiosyncrasies, such as a high hip, uneven shoulders, extreme back curvature, and so forth. The sloper can be modified to take these idiosyncracies into account and can then be re-fitted onto the digital “body.” Once the sloper properly fits the body, seam allowances are added, and the sloper is printed out at full scale and provided to the individual.

This method distinguishes over all known art in that it provides access to very accurate basic patterns that can be used to modify existing (“ready-to-wear”) clothing, easily modify commercial patterns to achieve a more accurate fit, or allow one to easily work with a design or personal tailor to obtain custom clothing.

As noted, the method is quick, very quick in fact (the scan takes only about 30 minutes and the patterns can be delivered within a handful of business days). The method is also very inexpensive (a set of slopers is currently around $200.)

It is yet another object and advantage of the present invention to enable people to have much more involvement in establishing their own personal fashion identity, as expressed in garment design and textiles employed.

Among the many contemplated uses, a principal use of the inventive method is for clients to use the sloper for creating custom clothing.

Yet another advantage of the inventive sloper generator is that it can be used several ways to make clothing that fits the client as nearly as perfect as possible.

### BRIEF DESCRIPTION OF SEVERAL VIEWS OF THE DRAWINGS

The invention will be better understood and objects other than those set forth above will become apparent when consideration is given to the following detailed description thereof. Such description makes reference to the annexed drawings wherein:

FIG. 1 is a schematic flow diagram setting out the principal method steps involved in the inventive method for providing precise slopers for customer tailored clothing;

FIG. 2 is a detailed schematic flow chart showing the steps involved in extracting measurements obtained in an earlier body scan step; and

FIG. 3 is a detailed schematic flow chart showing the process of draping the sloper on the body scan.

### DETAILED DESCRIPTION OF THE INVENTION

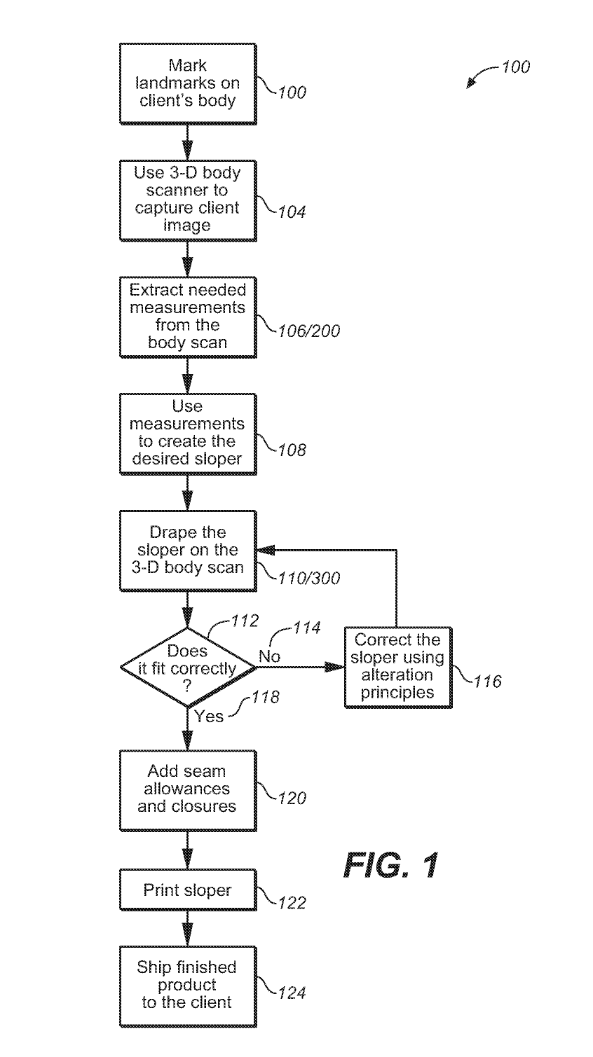

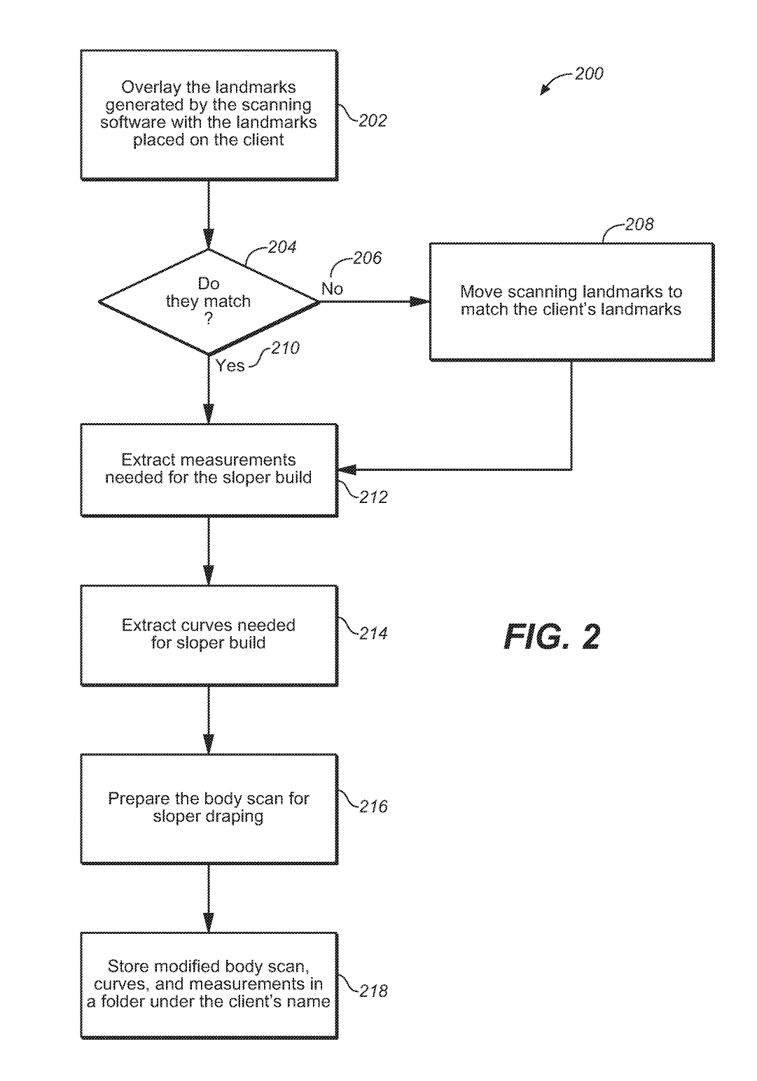

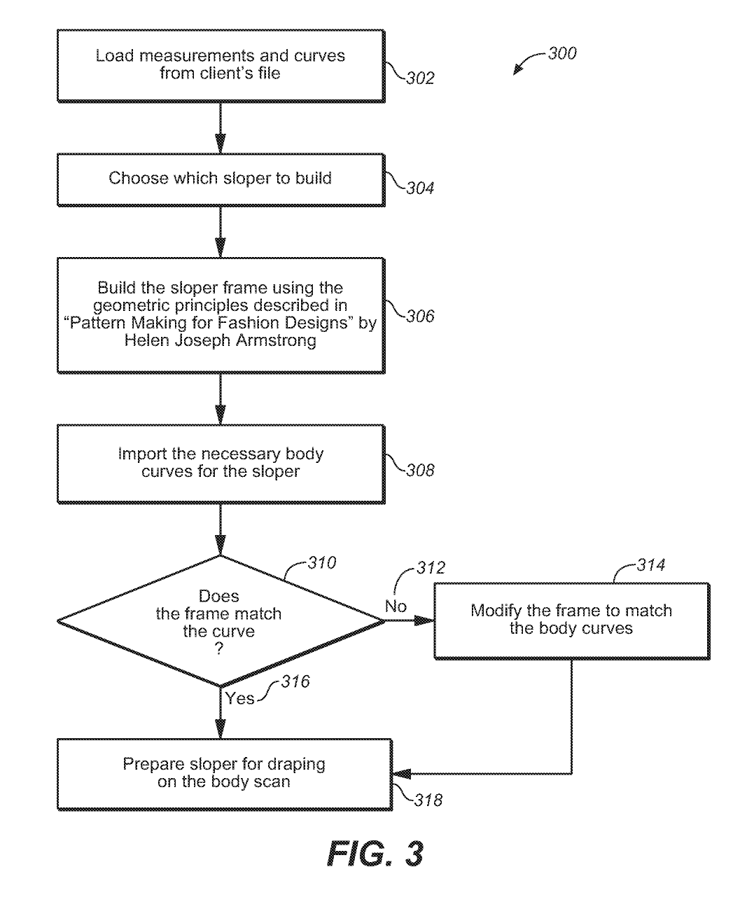

Looking now at FIGS. 1-3, initially at FIG. 1, with FIGS. 2 and 3 being detailed views of particular method steps set out in FIG. 1, there is shown the steps included in the inventive method for providing precise slopers for custom tailored clothing.

To prepare for the entire sloper generation process 100, a customer/client wears close (but not tight) fitting clothing to get an accurate body scan. An example might be a leotard or tank top, but not a swimsuit.

Stickers are then placed at landmarks on the body 102 and several preliminary test measurements are made. Landmarks are located at the bust or chest, waist, abdomen, and hips in quadrants (i.e., center front and back, and left and right sides).

The customer is then scanned using a 3-D body scanner 104. The person is scanned using the Size Stream SS16 body scanner. This scanner uses IR and visible light technology to capture the shape/form of the client. The visible light scan will pick up the landmarks that were visibly placed on the client in step 1. As part of this step, the accuracy and landmark placement is checked. Landmarks generated by the scanner can be moved to match the ones placed on the body.

Using the inventive sloper program, which is executed on a computer having permanent and temporary memory and a processor, the sloper program extracts the client's measurements from the body scan 106. This step is detailed in the steps set out in FIG. 2.

After the measurements are extracted, the program next uses the measurements to geometrically draw a custom body block or sloper 108. The sloper is then draped onto the 3D body scan 110, details of which are set out in FIG. 3, and discussed more fully below.

Placing/draping the drawn sloper on the body scan allows one to test the fit 112 and to find the idiosyncrasies at play (high hip, uneven shoulders, extreme back curvature, etc.) and then “tweek” the pattern for an accurate fit of the body. If the sloper does not fit correctly 114, it is corrected using alteration principles 116 and passed back to the draping step 110.

Once the sloper fits the body scan 118, it has seam allowances and closures added as per the client's instruction 120.

Once the correct fit has been achieved, the pattern is then returned to the CAD program employed (e.g., AutoCad) where it is printed out full scale using a plotter printer 122, such as an HP DesignJet plotter. The pattern is printed on plain medium bond paper, which is sturdy enough to last, but allows one to use it to cut fabric. The printed sloper is then either shipped to the client or delivered to a tailor 124.

Looking next at FIG. 2, details are shown how the measurements extracted from the 3D body scan are used by the program to create a desired sloper, the process generally denominated as 200 [corresponding to Ref. No. 106 of FIG. 1].

Preliminarily, it must be noted that it is imperative that the landmarks generated by the scanner software match the landmarks placed on the client at the scanning session (i.e., those located on the body at the bust or chest, waist, abdomen, and hips in quadrants).

The scanned data is processed in a program provided by Size Stream which allows one to manipulate both the IR and visible light data. The program enables the user to align (overlay) the scanned data's landmarks to those placed manually before the scan was taken 202. The program tests for match 204, and if the landmarks generated by the scanning software do not align with the landmarks on the client 206, the scanning landmarks are moved to match the client's landmarks 208. When the landmarks match 210, the operation passes to the operation of extracting measurements needed for the sloper build 212. Measurements are extracted by surface measurements between landmarks.

Body curves are extracted by generating the needed lines on the body surfaces 214. Depending on the shape of the client, curves can be extracted using either Photoshop and AutoCad or, if the client is very large, slice and measure techniques in a modeling and animation program, such as the 3ds Max modeling, animation, and rendering program. Curves extracted include front and back neck, front and back armhole, front, back and side hip, and front and back crotch. These curves are unique to each client.

The body scan is prepared for draping by making sure that the scan gives an unobstructed, clean access to the arm pit and crotch area for fitting sleeves, shirts, and pants 216.

The modified body scan, extracted measurements and body curve are all saved in a folder under the client's name 218.

Referring now to FIG. 3, there is shown the steps comprising the operation of draping the sloper onto the body scan 300 [corresponding to Ref. No. 110 from FIG. 1].

The process uses a program written in C Sharp (C#) using dotNet protocol. The program allows the user to develop geometric shapes in CAD and to import shapes for insertion into drawings. As a first step, the measurements and curves from the client's file are loaded into the program 302.

The user chooses which sloper will be built (for instance, whether it is a bodice, shirt, skirt, women's pants, men's pants, etc.) 304.

Next, the frame is built (which comprise the straight lines of the sloper) 306 using the geometric principles described in “Pattern Making for Fashion Design” by Helen Joseph Armstrong. This gives an “approximate” fit for the sloper by matching the sloper to “key areas” of the body (bust, waist, hips, etc.).

At this point one would usually draw “an appropriately shaped line” for the curves of the body, depending on which sloper is being built. In a preferred embodiment of the inventive method, the extracted curve from the client's body scan is next used because the scan is the exact curve, and one can now fit the frame to the curve for a more accurate first draft 308.

The sloper is then laid out in such a way that it can be imported into 3ds Max, which can animate the body scan for fitting, and the frame is tested for match to the curve 310. While other modeling programs can be usefully employed, 3ds Max is highly discriminating about how points overlap. If the frame does not match 312, it is modified to fit the curve 314. Thus, only when it does match 316, is the operation passed to preparing the sloper for draping on the body scan 318. This process allows for fine tuning of the fit of the sloper for problems that have not been addressed. For instance, if a client has a high hip or unusually sloped shoulders, it will show as the sloper is draped on the body scan. In an embodiment, an animation program may be employed to renders 2D shapes into “cloth” which can be draped on a shape.

Once the pattern has been turned into “cloth,” it can be draped on the scanned body and the “seams” are “sewn” together. This is very much like having a client in for a fitting at a tailor's shop. It is possible to identify areas that are too tight or too loose, or a seam in the wrong place, etc. Classic alteration principles are used to adjust the sloper to fit the “body”.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention.

What is claimed as invention is:

1. A method for creating a customized clothing construction sloper for a clothing customer, comprising the steps of:
(a) manually placing physical landmarks on the customer;
(b) scanning the customer using a 3D body scanner;
(c) providing a computer having permanent and temporary memory and a processor;
(d) loading a sloper program on the computer, wherein when executed the sloper program performs the steps of:
(d1) generating scanning landmarks using the scanned data;
(d2) aligning the scanning landmarks to the physical landmarks;
(d3) testing for alignment of the scanning landmarks with the physical landmarks;
(d4) moving the scanning landmarks as needed to match the physical landmarks;
(e) extracting customer measurements from the body scan;
(f) geometrically drawing a custom sloper using the extracted measurements;
(g) draping the sloper onto the 3D body scan;
(h) testing the fit of the sloper to identify individual fit characteristics of the customer;
(i) modifying the sloper as needed using alteration principles to make the fit more accurate;
(j) passing the sloper back to the draping step and repeating steps (g) through (i) until the sloper fits the customer; and
(k) adding seam allowances and closures as needed.

2. The method of claim 1, wherein the physical landmarks are landmark stickers.

3. The method of claim 1, further including printing a full scale of the sloper on pattern paper.

4. The method of claim 1, further including fitting the customer with close-fitting scan garment prior to placing landmark stickers for use in obtaining a body scan.

5. The method of claim 1, wherein the physical landmarks are placed in quadrants at the customer's bust or chest, waist, abdomen, and hips.

6. The method of claim 5, wherein the physical landmark placement in quadrants is at the center front and back, and left and right sides of the customer.

7. The method of claim 1, further including taking one or more preliminary test measurements to check the accuracy of the physical landmark placement prior to scanning.

8. The method of claim 1, wherein the 3D scanner uses infrared and visible light to capture the form of the customer.

9. The method of claim 1, further including moving landmarks generated by the scanner to match the landmarks placed on the customer.

10. The method of claim 1, wherein the extracting step (e) includes generating lines and curves on the body surfaces.

11. The method of claim 10, wherein the step of generating needed lines further includes using slicing and measuring techniques in a modeling and animation program.

12. The method of claim 1, further including saving the extracted measurements and body curves in a digital file folder.

13. The method of claim 1, wherein the draping step (g) includes:
loading the measurements and curves from the customer's file into the sloper program;
choosing which sloper will be built;
building the frame to obtain an approximate fit;
drawing a shaped line for the curves of the customer's body depending on the chosen sloper being built;
fitting the frame to the shaped line for a more accurate first draft;
importing the sloper into a modeling and animation program;
animating the body scan for fitting; and
testing the frame for its match to the customer's body.

14. The method of claim 13, further including preparing the sloper for draping on the body scan when the frame matches the curve.

15. The method of claim 13, wherein the draping step further includes rendering a 2D cloth shape in the modeling and animation program.

16. The method of claim 15, further including draping the 2D cloth shape onto the body scan.

17. The method of claim 16, further including sewing the seams together to identify areas that are too tight or too loose or any improperly located seams.

18. The method of claim 17, further including adjusting the sloper to fit the customer's body.
